(19) United States
(12) Patent Application Publication
(10) Pub. No.: US 2006/0008086 A1
(43) Pub. Date: Jan. 12, 2006

(54) Image encryption method and visual decryption device

(75) Inventors: Thomas Andreas Maria Kevenaar, Eindhoven (NL); Mark Thomas Johnson, Eindhoven (NL); Geert Jan Schrijen, Eindhoven (NL); Pim Theo Tuyls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,870

(22) PCT Filed: Aug. 27, 2003
(86) PCT No.: PCT/IB03/03842

§ 371 Date: Mar. 4, 2005

(30) Foreign Application Priority Data
Sep. 9, 2002 (EP) 02078660.4

(51) Int. Cl. H04L 9/00

(52) U.S. Cl. 380/43

(57) ABSTRACT

A method of encoding a graphical message (220, 221) based on a key sequence as an encoded sequence of information units. For each pixel of the message, said pixel having a normalized intensity I, a total rotation α which results in a liquid crystal display in a pixel with substantially the intensity I is determined. The key sequence contains arbitrary rotations. The difference between the total rotation a and a corresponding rotation in the key sequence is output as an element of the encoded sequence. A device (201) presents pixels with rotations indicated by the encoded sequence on a first display (701) and pixels with rotations indicated by the key sequence on a second display (211). Superimposing the two displays reveals the graphical message. The method can be repeated for red, green and blue intensities of color pixels, allowing colored graphical messages to be encoded and reconstructed.

The invention relates to a method of encoding a graphical message based on a key sequence as an encoded sequence of information units, and to a decryption device for reconstructing such a graphical message given the key sequence.

Visual cryptography (M. Naor, A. Shamir: Visual Cryptology, Eurocrypt '94, Springer-Verlag LNCS Vol. 950, Springer-Verlag, 1995, pp 1-12) can briefly be described as follows. An image is split into two randomized parts, the image plus a randomization and the randomization itself. Either part contains no information on the original image because of the randomization. However, when both parts are physically overlaid the original image is reconstructed. An example is given in FIG. 1: original image 100 is split into shares 110 and 120, which when overlaid result in reconstructed image 130.

If the two parts do not fit together, no information on the original image is revealed and a random image is produced. Therefore if two parties want to communicate using visual cryptography, they have to share the randomization. A basic implementation would be to give a receiving party a transparency containing the randomization. The sender would then use this randomization to randomize the original message, and transmits the randomized message to the receiver, on a transparency or by any other means. The receiver puts the two transparencies on top of each other and recovers the message. This scheme can be compared to a one-time pad.

A more flexible implementation is obtained when using two display screens, e.g. two LCD screens. A first screen displays the image plus randomization and a second screen displays the randomization itself. If the screens are put on top of each other, the reconstructed image appears. European patent application 02075527.8 (attorney docket PHNL020121) describes a device capable of reconstructing graphical messages produced using visual cryptography. This device makes use of the polarization rotating effect of liquid crystal cells in a liquid crystal display.

Polarization filters in liquid crystal displays only let light through with a particular polarization. Normally a liquid crystal cell rotates the polarization of the light that passes through it over a certain angle. If a sufficient voltage is applied to the cell, no rotation takes place. This is referred to as “activating” that cell. Light will not be visible if the total rotation of the polarization of the incoming light after passing through the two superimposed liquid crystal layers is perpendicular to the polarization direction of the second polarization filter.

After receiving a sequence of information units, preferably a sequence of binary values, the device renders the sequence on the first liquid crystal display by activating or not activating cells in the liquid crystal layer. No processing or decryption step is necessary before any displaying takes place; the information units are displayed as they are received. On a second display another pattern is displayed, which is generated based entirely on a key sequence.

Reconstruction of the image is performed by superimposing the first and second displays in the correct alignment, so that the user can see the reconstructed graphical message. The reconstruction is performed directly by the human eye and not by a device which might be compromised. This makes the use of visual cryptography to communicate secret information more secure.

The above-mentioned European patent application 02075527.8 describes that the polarization of the individual cells in the liquid crystal layers is rotated over 0 or 90 degrees in the case of transmissive displays, or over 45 degrees in the case of reflective displays. This means that the method and device in this application can only encode and reconstruct graphical messages in pure black and white.

It is an object of the present invention to provide a method according to the preamble which maintains the resolution and brightness of the original graphical message, and which permits the encoding of graphical messages comprising pixels of arbitrary intensities such that reconstruction maintains those intensities.

This object is achieved according to the invention in a method comprising for each pixel of the graphical message, said pixel having a normalized intensity I: determining a total rotation value a representing a rotation of a polarization of a cell in a liquid crystal display resulting in a pixel with substantially the intensity I, choosing an element a2 from the key sequence, the element representing an arbitrary rotation of a polarization of a cell in a liquid crystal display, computing a first message value al as a difference between the rotation value α and the element α₂, and outputting an element of the encoded sequence based on the first message value α₁.

In principle it is possible to rotate the polarization of light in a liquid crystal display over an arbitrary angle within a certain range, say [0, π/2] or [0, π], depending on the construction of the liquid crystal display and the applied voltage over a liquid crystal cell. It is possible to cause a pixel to appear with a particular intensity depending on the chosen angle. However, varying the intensity is not described or suggested in the above-mentioned patent application.

According to the present invention, rather than encoding pixels of the graphical message as binary values, as is done in the prior art, the intensity of the pixels in the message is now used in the encoding. The key sequence now essentially represents a series of arbitrarily chosen rotations rather than arbitrarily chosen black or white pixels. An element of the encoded sequence is computed based on the difference between a rotation indicated by an element of the key sequence and the total rotation for a particular pixel of the graphical message.

If the key sequence is chosen carefully, it will not be possible to reconstruct the graphical message given only the encoded sequence (the “first share” in visual cryptography terminology). However, a recipient who has both the encoded sequence and the key sequence can display them on two respective liquid crystal displays. The intensity of the pixels on the respective displays is controlled in accordance with the values indicated in the respective sequences. Superimposing the two displays causes the original message to appear in its original quality and with pixels having substantially the same intensity or gray scale values.

In an embodiment the method further comprises computing an intermediate value x as x=arccos(|√(I)|) and determining the value a as either x or π−x. Both x and π−x represent rotations that result in the desired intensity I. It is now possible to obtain different message values al for two different pixels with the same normalized intensity even when the corresponding key element α₂ is the same for both pixels.

In a further embodiment the normalized intensity I corresponds to an intensity of a first color component of the pixel in question, and the method further comprises repeating the determining, choosing and computing steps for a second rotation value corresponding to a normalized intensity of a second color component of said pixel to obtain a second message value, repeating the determining, choosing and computing steps for a third rotation value corresponding to a normalized intensity of a third color component of said pixel to obtain a third message value, and outputting the element of the encoded sequence further based on the second and third message values.

In color LCDs, one color pixel is built from three sub-pixels or color components. Each sub-pixel has a respective different color (red, green and blue) by, for example, applying a color filter. As with gray scales, the intensity of each of the colors can be changed individually by changing the respective rotations (α_{R}, α_{G} and α_{B}) and this way, pixels with any color can be produced. Thus a colored pixel can be represented as a set of three intensities or as a set of three rotations. By applying the determining, choosing and computing steps for all three intensities of a pixel, a set with three message values is obtained for that pixel. The encoded sequence now contains information on the color of the pixel, which allows reconstruction of the graphical message in the original colors.

In practice a pixel intensity is not always taken arbitrarily from the range [0, 1], but instead is often limited to, say, 256 possible values. This means that the number of possible values for the message value and the corresponding element of the key sequence is limited as well. If these values are not carefully chosen, fewer intensities are available for the reconstructed image than would be theoretically possible. To increase the number of possible intensities, in an embodiment an arbitrarily chosen offset Δ is added to the message value, to the key sequence value (the element α₂), or distributed over both.

The invention further advantageously provides for a computer program arranged for causing a processor to execute the method of the invention. In this way, the invention can be carried out on any computer system.

It is a further object of the invention to provide a decryption device according to the preamble, which is able to reconstruct graphical messages encoded according to the method of the invention while substantially maintaining the resolution and brightness of the original graphical message and the intensities of the pixels therein.

This object is achieved according to the present invention in a device comprising receiving means for receiving an encoded sequence of information units, a first liquid crystal display arranged for displaying the sequence of information units by rotating the polarization of respective cells in a first liquid crystal layer by an amount indicated by respective elements in the encoded sequence, a second liquid crystal display, different from the first liquid crystal display, arranged for rotating the polarization of respective cells in a second liquid crystal layer by an amount indicated by respective elements in the key sequence, in which the first and second liquid crystal display are arranged to be superimposed on each other.

Various advantageous embodiments of the device are set out in the dependent claims.

These and other aspects of the invention will be apparent from and elucidated with reference to the embodiments shown in the drawings, in which:

FIG. 1 shows an original image, two shares obtained by visually encrypting the original image and a reconstructed image obtained by superimposing the two shares;

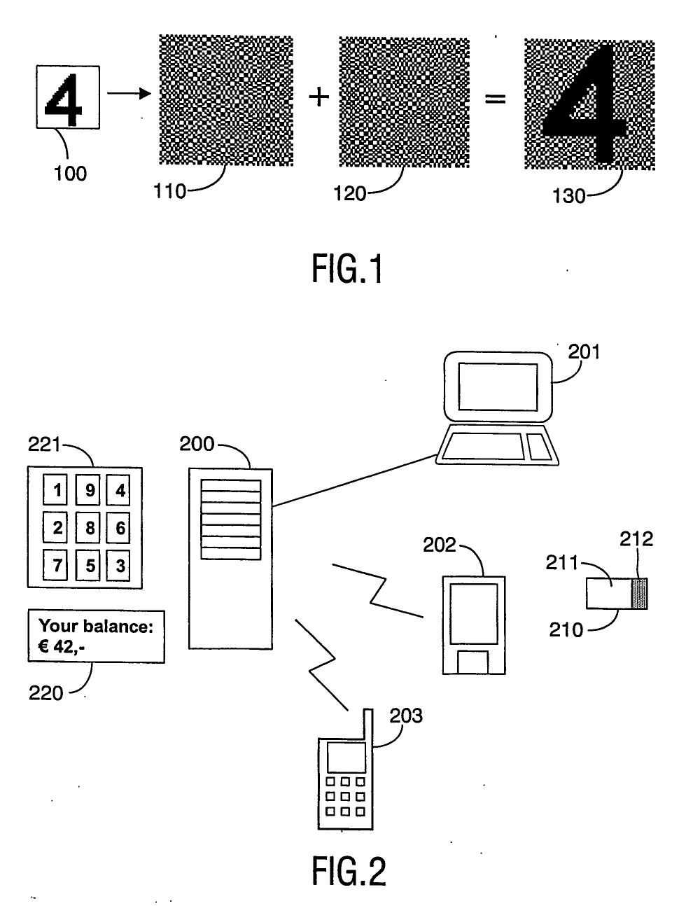

FIG. 2 schematically shows a system comprising a server and several clients;

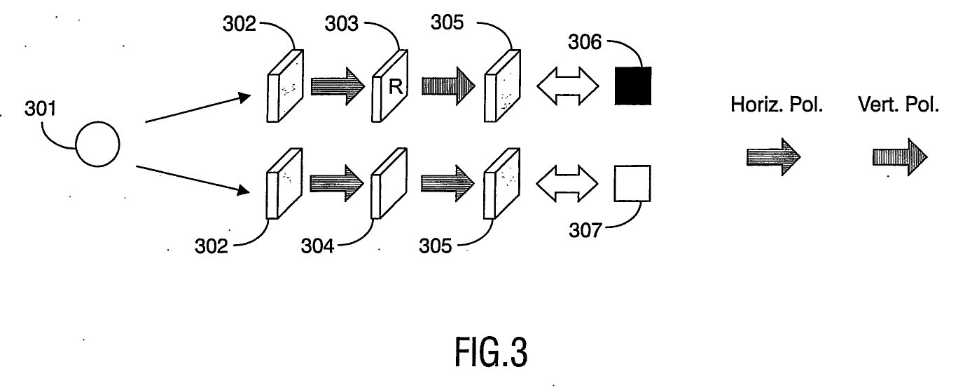

FIG. 3 schematically shows the construction of a liquid crystal display (LCD);

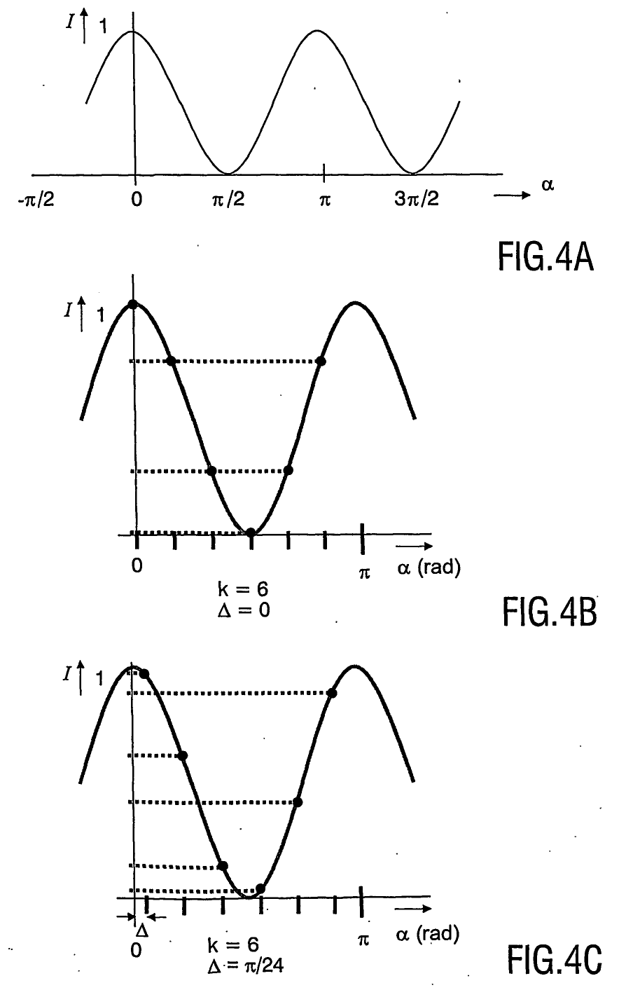

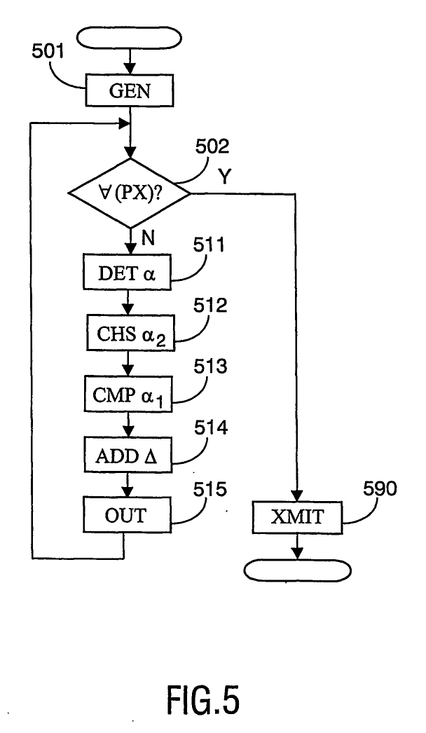

FIGS. 4A-C graphically show the intensity of a pixel in an LCD as a function of a rotation a in various situations;

FIG. 5 schematically illustrates a first embodiment of the encoding method performed by the server to visually encrypt a graphical message;

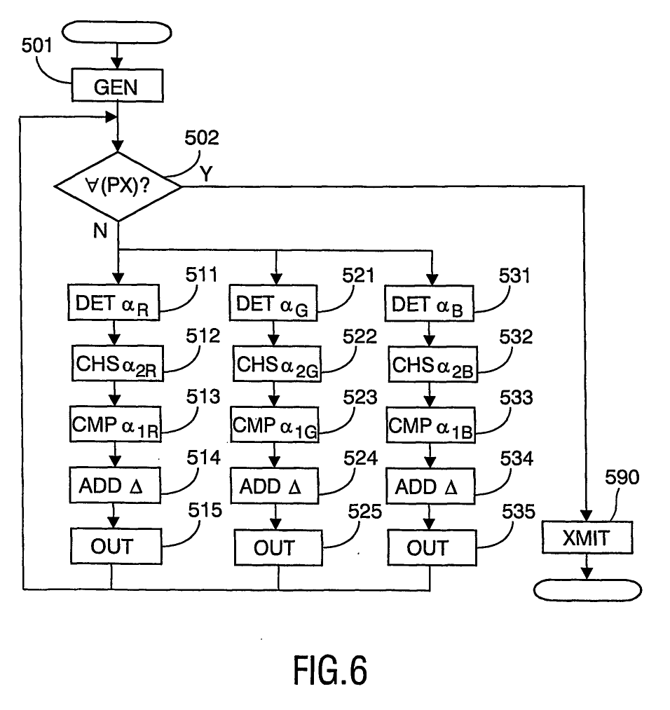

FIG. 6 schematically illustrates a second embodiment of the encoding method;

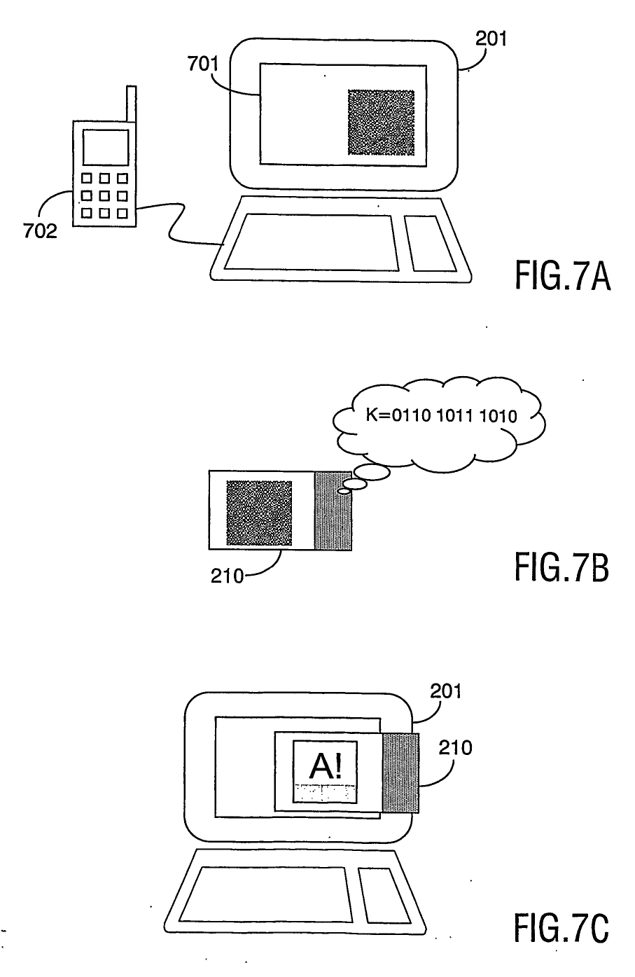

FIGS. 7A-C schematically illustrate the operations of the client device; and

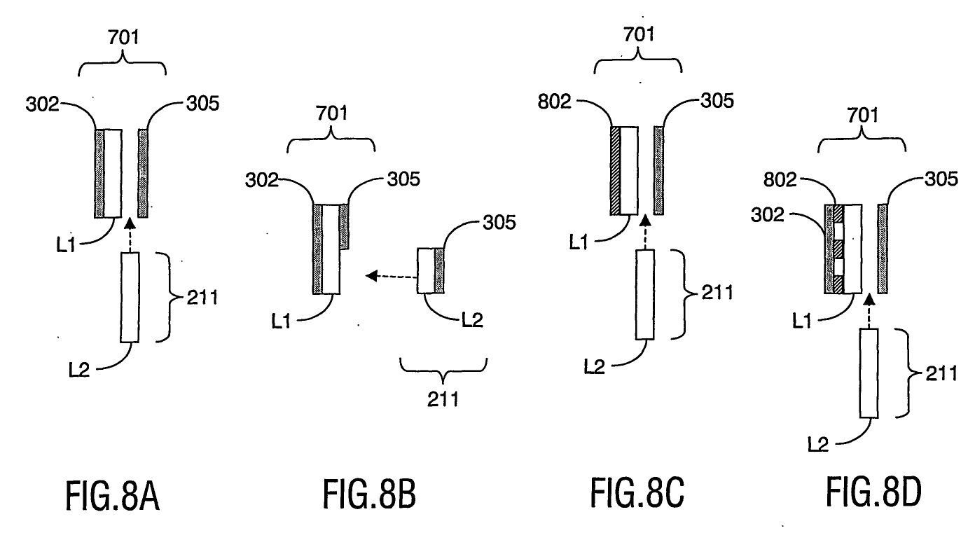

FIGS. 8A-D illustrate various embodiments for the first and second liquid crystal displays used in the client device.

Throughout the figures, same reference numerals indicate similar or corresponding features. Some of the features indicated in the drawings are typically implemented in software, and as such represent software entities, such as software modules or objects.

FIG. 2 schematically shows a system according to the invention, comprising a server 200 and several clients 201, 202, 203. While the clients 201-203 are embodied here as a laptop computer 201, a palmtop computer 202 and a mobile phone 203, they can in fact be realized as any kind of device, as long as the device is able to interactively communicate with the server 200 and is able to render graphical images on an LCD screen. The communication can take place over a wire, such as is the case with the laptop 201, or wirelessly like with the palmtop computer 202 and the mobile phone 203. A network such as the Internet or a phone network could interconnect the server 200 and any of the clients 201-203.

The server 200 generates an image representing a message that needs to be communicated to the operator of the client 201. The image will be encoded using visual cryptography before transmission, as will be discussed below with reference to FIG. 5. The graphical message can of course comprise any type of information that one could want to transmit securely and privately to another party. For example, a customer's bank balance could be communicated this way, as shown in FIG. 2 as graphical message 220. Other examples include private e-mail messages, a new PIN code or password to be provided to the operator of client device 201.

A particularly advantageous application is to securely allow composition of a message by the operator of client 201. In this embodiment, the server generates an image 221 which represents a plurality of input means such as keys on a keyboard. Each input means represents an input word that can be used in the message that will be composed by the user. Next to keys, the input means could also be checkboxes, selection lists, sliders or other elements typically used in user interfaces to facilitate user input. This application is discussed in more detail below.

The server 200 encodes the image 220, 221 as a sequence of information units based on visual cryptography. This encoded sequence is then transmitted to one of the client devices 201-203. Such transmissions are straightforward to implement and will not be elaborated upon here. Note that it is not necessary to protect this transmission by e.g. encrypting the encoded sequence or setting up a secure authenticated channel, before transmitting it. Because of the process used to choose the elements of the sequence, it is impossible for an eavesdropper to recover the image 220,221 by using only the encoded sequence.

Also shown in FIG. 2 is a personal decryption device 210. This device 210 is personal to a user and should be guarded well, as it is to be used to decrypt visually encoded messages sent by the server 200 to any of the clients 201-203. Anyone who gains physical control over the decryption device 210 can read all visually encrypted messages intended for the user. To add some extra security, entering a password or Personal Identification Number (PIN) could be required upon activation of the decryption device 210. The device 210 could also be provided with a fingerprint reader, or be equipped to recognize a voice command uttered by its rightful owner.

The decryption device 210 comprises a display 211 and a storage area 212. The display 211 is preferably realized as an LCD screen with nematic liquid crystals. Although normally such a display 211 would have a polarization filter on both sides of the liquid crystal layer, in this embodiment the display 211 only has one polarization filter (see also FIG. 8B). The LCD screen of the client 201 that receives the visually encrypted message should then have a portion of the topmost polarization filter removed. This portion should be large enough to allow the display 211 to be superimposed upon it. Alternatively, the LCD screen of the client 201 can be provided with a (preferably small) separate display on which the display 211 is to be superimposed. In another embodiment (shown below with reference to FIG. 8A) the display 211 has no polarization filter.

The storage area 212 comprises at least a key sequence to be used in decrypting visually encrypted images. Elements of the key sequence represent arbitrary rotations of the polarization of cells in the display 211. The length of the key sequence stored in the storage area 212 should be long enough to accommodate a large number of decryption operations. When decrypting visually encrypted images, one element is necessary for each pixel of the original input image.

After every decryption operation, the key elements used are preferably discarded or marked as used. In this way every decryption operation involves the use of a unique subsection of the key sequence. When all key elements have been used, the key sequence in the storage area 212 must be replaced. This can be realized by e.g. asking the owner of the decryption device 210 to replace his decryption device 210 with a new specimen, or to visit a secure location like a bank where it is loaded with a new key sequence.

Alternatively, when a key sequence has been used, a cryptographic hash function or symmetric encryption scheme can be applied to the key sequence. The output of the hash function or encryption scheme is then used as the new key sequence. In this way a series of key sequences can be generated of any length, without having to store all of the key sequences in the personal decryption device 210. Of course, if even one key sequence in the series becomes known to an attacker, the attacker can also reconstruct all future key sequences.

Another, more secure alternative is to employ a stream cipher (e.g. RC4 or SEAL) as a key generator. Stream ciphers encrypt plaintext one bit (or sometimes byte) at a time. The stream of plaintext bits are XORed with the output of a keystream generator which produces a pseudo-random stream of bits based on a seed value, which could be stored in the memory 212. This seed value is the key for the stream cipher. The stream of bits is used to derive arbitrary rotations which make up the key sequence.

The decryption device 210 also needs to be equipped with hardware and/or software modules (not shown) capable of performing the above cryptographic operations. This could be realized e.g. by adding a processor and a memory comprising the software.

The decryption device 210 is preferably embodied as a unit physically separate, or at least separable, from the client device 201-203. No electrical, optical or other communication paths between the decryption device 210 and the client should exist. As the patterns and the key sequence are provided in digital (electronic) form, any such communication paths could potentially be abused by an attacker to obtain a portion of the key sequence. Without such paths, a compromised client device cannot obtain information from the decryption device 210 in any way. In this way, it is achieved that the user does not have to trust the security of the client 201.

In order to understand the present invention's use of liquid crystal displays for visual cryptography, first consider the construction of a common fransmissive liquid crystal display (LCD) in a backlight setting, as shown in FIG. 3.

A light source 301, typically realized as a backlight positioned behind the LCD screen, projects light waves with all possible polarizations towards a polarization filter 302. Only light waves with one particular polarization pass through this polarization filter 302. The liquid crystal cells 303, 304 normally rotate the polarization of the light waves passing through them over a certain angle within a certain range, usually [0, π/2] or [0, π/4], depending on the construction of the liquid crystal display and the voltage applied to the cells 303,304.

The cells 303, 304 in this embodiment are twisted nematic liquid crystals, which is the most common type. Other types could of course be used instead. Also, rather than using a backlight, a reflective or transflective liquid crystal display could be used.

If a particular voltage is applied to a liquid crystal cell, the inner molecular structure of the cell changes in such a way that the polarization of passing light is altered by a particular amount. In FIG. 3, a voltage has been applied to liquid crystal cell 304, but not to liquid crystal cell 303. To indicate that liquid crystal cell 303 rotates the polarization of passing light, it has been marked with the letter “R”. For the sake of clarity, the rotation effected by liquid crystal cell 303 is shown in FIG. 3 as λ/2 or 90 degrees, although the rotation can in this case be any amount between 0 and π/2.

The light waves that passed through liquid crystal cells 303, 304 subsequently cross a second polarization filter 305. This polarization filter 305 acts like polarization filter 302 in that it only allows light waves with one particular polarization to pass through. Because the polarization of the light that passed through liquid crystal cell 303 had been rotated, this light is blocked by the polarization filter 305, and so the output will appear as a black pixel 306. The polarization of the light that passed through activated liquid crystal cell 304 is unaltered, and so it passes through polarization filter 305 and appears as a white pixel 307. To produce gray scale output, the polarization is rotated in this example somewhere between 0 and π/2. This means that only some of the light is let through by the polarization filter 305, which results in an output pixel with a lower intensity.

Alternatively, the second polarization filter 305 could be chosen to let only light through that has been rotated over π/2 by the liquid crystal cell 303. The output of the liquid crystal display will then be exactly opposite to what has been described above. However, this is a mere design variation.

The normalized intensity I of the output pixel can be expressed as a function of the rotation effected by the liquid crystal cell. One such function, graphically shown in FIG. 4A, is I=cos²(α).

For performing visual cryptography, rather than a single layer of liquid crystals, there are now two layers of crystals between the polarization filters 302 and 305. Voltages can be applied to the cells in each layer separately to active these cells. The intensity of the output pixel now can be expressed as a function of the rotations effected by the cells in the two layers. If the cell in the first layer rotates by an amount α₁ and the cell in the second layer rotates by an amount α₂, then the above function becomes:
I=cos²(α₁+α₂).

As explained with reference to FIG. 2, the personal decryption device 210 contains a key sequence. An element of this sequence represents the rotation α₂ of the polarization of a particular corresponding cell in the display 212. This rotation α₂ is chosen (pseudo-)randomly from a certain range. The rotation α₁ is then chosen such that the intensity Iᵣ of the reconstructed pixel is substantially equal to the intensity I of the pixel in the graphical message 220, 221.

Liquid crystal displays can rotate the polarization direction of the polarized light which emerges from the polarizer. Liquid crystals are molecules which have the property that the refractive index n is different along the molecular axis and at right angles to this. The difference in refractive index (Δn) is called the birefringence. When polarized light passes through the liquid crystal, the birefringence causes the direction of polarization to change. There are many configurations of liquid crystals which are known from the prior art in which the preferred rotation of π can be realized. See for instance pp. 66-67 of S-T. Wu and D-K. Yang, Reflective liquid crystal displays, John Wiley and Sons Ltd., ISBN 0-471-49611-1.

In the most simple configuration of a nematic liquid crystal whose molecules only rotate in one direction, the rotation a (in radians) is given by

$$α = \frac{2 π d Δ n}{λ}$$

where d is the thickness of the cell and λ the wavelength of the light. By choosing for example the cell gap and birefringence of the liquid crystal properly, it is possible to construct a cell with the required preferred rotation of π.

A preferred method to create an encoded sequence from the graphical message 220 or 221 given a key sequence is illustrated in FIG. 5. First, the graphical message 220 is generated in step 501. This message 220 can simply be a graphical representation of a textual message, but might also comprise images.

Next, steps 511-515 are performed for every pixel in the graphical message 220. Decision step 502 determines whether every pixel has been processed in this way, and if so, branches to step 590 in which the encoded sequence is transmitted to the client device 201. The encoded sequence may be compressed before transmitting in step 590 to save bandwidth.

Each pixel has an intensity I. It is assumed that this intensity I is normalized to a range [0, 1]. In step 511, the server 200 determines a total rotation value α representing a rotation of a polarization of a cell in a liquid crystal display that results in a pixel with substantially the intensity I. This can be done e.g. by computing α=arccos(|√I|). Preferably the server 200 first computes an intermediate value x as x=arccos(|√(I)|) and selects the value α as either x or π−x. This choice between x and π−x can be made randomly.

In step 512 the server chooses an element α₂ from the key sequence. As the reader will recall, this same element is present in or can be computed by the personal decryption device 210. The personal decryption device 210 presents a pixel on the display 211 by rotating the polarization of the corresponding cells in the liquid crystal layer in the display 211 by an amount indicated by the element α₂. Since it is not possible (or desired) to communicate the value of α₂ to the personal decryption device 210, the server 200 must keep track of which element to use next. The element α₂ thus represents an arbitrary rotation of a polarization of a cell in a liquid crystal display.

Using the computed total rotation value a and the element α₂, the server computes α₁ as a difference between these values in step 513. If this difference is negative, a value of π can be added to obtain a positive rotation α₁.

The rotations α₂ used in the key sequence should be chosen from a range of size λ. This has the advantage that an eavesdropper who obtains α₁ cannot learn anything about α₂ or Iᵣ. If α₂ is chosen from a smaller range, the Probability Density Function (PDF) of Iᵣ depends on α₁, or, P(Iᵣ|α₁)≠P(Iᵣ) and this reveals some information on Iᵣ.

In step 515 an element of the encoded sequence is output indicating the computed value α₁. This value indicates the rotation necessary, together with the arbitrary rotation indicated by α₂, to obtain the original intensity I. There are of course many ways in which this element can be output. It can be e.g. simply a numeric value representing α₁ itself, or a value which the client device 201 can translate into the correct rotation. For instance, a set of discrete values for amounts of rotation can be assigned respective identifiers, and those identifiers can then be output in the encoded sequence.

If the properties of the LCD screen in the client device 201 are known to the server 200, then it becomes possible to create the encoded sequence as an image with pixels having respective intensities, in which the respective intensities correspond to the computed rotations. Conventional LCD screens are already arranged to display such images by rotating the polarity of the cells in the liquid crystal layer accordingly. This has the advantage that the client device 201 needs no hardware modifications and can display the image using standard graphics rendering software.

A possible algorithm for computing al and outputting a corresponding element of the encoded sequence can be summarized as follows:
1. Compute x=arccos(|√I|)
2. Randomly choose α as either x or π−x
3. Pick an element α₂ from the key sequence
4. Compute α₁ as the difference between α and α₂
5. If α₁<0 then output as element of the encoded sequence α₁+π
6. Otherwise, output α₁
   The last two steps can be combined into one by outputting as element of the encoded sequence α₁ modulo π.

In the above it was assumed that the rotations α₁ and α₂ can take any value in the range [0, π]. In practice a pixel intensity is not always taken arbitrarily from the range [0, 1], but instead is often limited to, say, 256 possible values. This means that the number of possible values for the message value and the corresponding element of the key sequence is limited as well. With such a limited number of values, the security of the scheme may be reduced and the possible values of α₁ and α₂ must be chosen so as to obtain a secure scheme.

A possible choice for k possible values is α₁ᵢ=iπ/k with iε{0, . . . , k−1}and α₂ⱼ=jπ/k within jε{0, . . . , k−1}. This choice will lead to less than k possible intensities as is illustrated in FIG. 4B which shows the graph of the intensity as a function of α. For six discrete values the intensities are indicated as dots on this graph. Due to the symmetry of the plotted function, there are only four possible intensities as indicated by the dotted lines.

In order to maximize the number of possible intensities, an arbitrarily chosen offset Δ can be added to the element α₂. FIG. 4C illustrates the effect of introducing an offset Δ=π/24. There are now six different possible intensities, as illustrated by the six dotted lines in the graph. The possible values of α₁ and α₂ are as follows:
αₗᵢ=iπ/k with iε{0, . . . , k−1}
α₂ⱼ=jπ/k+Δ with jε{0, . . . k−1} and Δε(0,π/2k).

It is easy to see that, due to the π-periodicity of cos²(α), it holds that for any iε{0, . . . , k−1} there are k possible intensities I.
Iₗ=cos(lπ/k+Δ) with lε{0, . . . k−1}.

By observing the contents of the first share, an adversary gets no information on the intensity of a pixel in the original graphical message. The offset Δ can of course also be added to the message value al, or be distributed over both.

One way of computing values for i and j necessary to compute the message value α₁ and outputting a corresponding element of the encoded sequence in the case that only a limited set of discrete values is available can be summarized as follows:
1. Compute lε{0, . . . , k−1} such that

$$\vert I - {cos}^{2} ( \frac{l π}{k} + Δ ) \vert$$

is minimal;
2. l−j<0 then output i=l−j+k
3. Otherwise, output i=l−j

In color liquid crystal displays, one color pixel is built from three sub-pixels or color components. Each sub-pixel has a respective different color (red, green and blue) by applying a color filter. An additional fourth subpixel, having a neutral (grayscale) color, can be provided for better control of the brightness of the output. Of course cyan, magenta and yellow can easily be substituted for red, green and blue. Other ways to achieve color pixels, for example using only two color components, are also possible.

As with gray scales, the intensity of each of these color components can be changed individually by changing the respective rotations (α_{R}, α_{G} and α_{B}) and in this way, pixels of any color can be produced. Thus a pixel of any arbitrary color can be represented as a set of three intensities or as a set of three rotations. This allows the application of the inventive method for graphical messages in arbitrary colors, rather than in arbitrary grayscales as was the case in the embodiment of FIG. 5.

In FIG. 6, the method of FIG. 5 is extended with respective determining steps 521, 531, choosing steps 522, 532, computing steps 523, 533, delta adding steps 524, 534 and output steps 525, 535 for all three intensities of a pixel. The skilled reader will understand that the steps 521-525 and 531-535 are in essence identical to the steps 511-515 as set out previously. They simply operate on the individual intensities of the green and blue sub-pixels. The steps 511-515 now operate on the individual intensity of the red sub-pixel.

The result is a set with three rotations α_{1R}, α_{1G} and α_{1B} (for red, green and blue) is obtained for that pixel. The encoded sequence now comprises such a set for each pixel of the colored graphical message, and so contains information on the color of the pixel, which allows reconstruction of the graphical message in the original colors.

FIGS. 7A-C schematically illustrate the operation of the client device 201. The client device 201 is in this embodiment connected to a network such as the Internet using a mobile phone 702, as is generally known in the art. Using a data connection established using the mobile phone 702, the client device 201 can transmit data to and receive data from the server 200.

In FIG. 7A, the device 201 receives the encoded sequence from the server 200 which was produced as set out above with reference to FIG. 5 or 6, and displays the elements of the sequence as respective pixels on a portion of liquid crystal display 701. This portion can be an area of a relatively large multi-purpose display, or the entirety of a relatively small dedicated display. The encoded sequence is displayed by rotating the polarization of respective cells in the liquid crystal layer in LCD 701 by an amount indicated by respective elements in the encoded sequence.

The sequence could for instance look something like {0, π/4, 3π/4, π/2, π/2, π/3, . . . }, i.e. directly indicating the desired rotations of the cells to produce pixels with a particular intensity. Alternatively, if particular intensities or rotations are assigned identifiers beforehand, then the sequence only needs to contain the appropriate identifiers. This typically reduces the length of the encoded sequence.

Observe that no processing or decrypting step is necessary in the device 201 before any displaying takes place; the bit sequence is displayed as it is received. It may be advantageous to display the pixels in a corner of the display 701, as will become apparent below. If the display 701 does not comprise a topmost polarization filter, the displayed black and white pixels will not become directly visible to a user.

Upon recognizing that a visually encrypted image has been sent to the client device 201, the user in FIG. 7B takes his personal decryption device 210 and activates it. This causes the decryption device 210 to output a graphical representation in dependence on the key sequence stored in storage area 212.

The decryption device 210 must be programmed in advance with the dimensions of the image that was generated by the server 200. Of course, an input means that allows the user to enter these dimensions for each image separately can also be provided, but this makes the decryption device 210 more complex and more expensive.

The decryption device 210 rotates the polarization of respective cells in the liquid crystal layer in the LCD 211 by an amount indicated by respective elements in the key sequence, similar to how the encoded sequence serves as a basis for rotation in the client device 201.

In FIG. 7C, the user superimposes the personal decryption device 210 upon the pixels displayed on display 701. To facilitate such superimposing, the edge of the display 701 can be provided with hooks or clamps in a corner (not shown), by which the personal decryption device 210 can be fastened to a particular position on top of the display 701. This way, it is very easy for the user to properly superimpose the personal decryption device 201 upon the patterns on the display 701 if these patterns are displayed in the corresponding position on the display 701.

Because both the decryption device 210 and the client device 201 each effectively display one share of a visually encrypted image, the user can now observe the reconstructed image. In the example of FIG. 7C, the reconstructed message is the textual message “A!” in black lettering with a grayscale bar below.

Because neither the client 201 nor the personal decryption device 210 at any time has sufficient information to reconstruct the image itself, the contents of the image 220 cannot be recovered by a malicious application running on either device. Further, since the personal decryption device 210 does not have any communication means, it is impossible to obtain the key sequence from the storage area 512 without gaining physical access to the decryption device 210.

One particularly useful application is to securely allow composition of a message by the operator of client 201. In this embodiment, the server generates the image 221 so that it represents a plurality of input means such as keys on a keyboard. Each input means represents an input word that can be used in the message that will be composed by the user. Next to keys, the input means could also be checkboxes, selection lists, sliders or other elements typically used in user interfaces to facilitate user input.

The server 200 then produces an encoded sequence for the image 221 and sends the sequence to the client device 201. The user positions his decryption device 210 above the area in which the bit sequence is displayed, activates the decryption device 210 and then is able to view the input means. The user then composes the message by selecting keys or other input means rendered as an image on the display of the client device 201. Such keys could be visually rendered as keys representing different alphanumerical characters, or as buttons representing choices like ‘Yes’, ‘No’, ‘More information’ and so on. Other ways to visually represent input means are well known in the art.

Selecting the input means is preferably done by selecting a particular set of coordinates on the display of the client device 201. Preferably, the user inputs the set of coordinates by applying pressure to a particular spot of the display, the set of coordinates corresponding to the particular spot. Because the image representing the input means can only be seen when the decryption device 210 is superimposed upon the client 201, the user is advised to apply pressure to the display 211 of the decryption device 210. This pressure will be transferred to the display of the client device 201, which when equipped with a touch-sensitive screen can register the spot to which pressure was applied, and translate this to a set of coordinates. Of course, other input devices such as a mouse, a graphics tablet or even a keyboard can also be used.

By itself it is known to allow composition of a message through visually rendered input means on a display, see e.g. U.S. Pat. No. 6,209,102. This US patent, however, does not protect the composed message against interception by an eavesdropper. It also fails to teach how such an image representing input means can securely be transmitted to the client device 201. This means that an eavesdropper can learn the layout of the input means represented on the image, and learn from the feedback sent by the client device 201 to the server 200 which input means were selected.

It is observed that different input means may, but need not necessarily, represent different input words. Providing multiple input means representing the same input word has the advantage that a sequence of inputs made by the user can appear to be random even when the sequence contains repetitions. As used here, the term “word” can mean single alphanumerical characters, but also texts like ‘Yes’, ‘No’ and so on, as well as other linguistic or symbolic elements.

Having received one or more sets of coordinates, the client device 201 transmits these sets of coordinates to the server 200. It is observed that eavesdropping software secretly installed on the client device 201 cannot learn any passwords or sensitive information entered in this fashion. At the most, such software would be able to learn the particular sets of coordinates entered in this particular session. These sets could then be used to impersonate the user in a future session.

To prevent this type of so-called ‘replay’ attack, the server 200 should randomize the placement of the input means on the image 221 every time. If the eavesdropping software then retransmits the sets of coordinates it learned, in order to impersonate the user in a subsequent session, the server 200 will not authenticate the impersonator, as the sets of coordinates do not correspond to the correct password or other authentication code. In fact, these sets of coordinates need not even correspond to the location of input means on the image generated in the subsequent session.

When the server 200 receives the sets of coordinates, it translates each set of coordinates to a particular input means represented on the image. Since the server 200 composed this image, translating a set of coordinates to an input means in the server 200 is straightforward. Finally, the message composed by the user is constructed as the input words represented by the particular input means to which the sets of coordinates were translated. See e.g. the above-mentioned U.S. Pat. No. 6,209,102 for more information.

While the message composed in the above fashion can of course contain any kind of information, preferably this message contains an authentication code such as a PIN code or a password. The server 200 can now check the PIN code or password to verify the credentials of the user, and grant access, perform one or more privileged operations or perform some other action for which these credentials are necessary. The server 200 could also signal another system upon a successful verification of the credentials.

FIGS. 8A-8D illustrate various embodiments for the liquid crystal displays 701 and 211. Ordinary liquid crystal displays are constructed as shown in FIG. 3, with two polarization layers and a layer with liquid crystals in between. However, in the invention there are two liquid crystal layers L1 and L2 superimposed on each other, without intervening polarization layers.

In FIG. 8A, the liquid crystal display 701 comprises first polarization layer 302, liquid crystal layer L1 and second polarization layer 305. A space has been left open between liquid crystal layer L1 and second polarization layer 305, which is large enough to accommodate the insertion of the liquid crystal display 211. This may require an opening in the client 201 in which the liquid crystal display 701 is installed, so that the user can easily perform the insertion.

The opening or slot can be either between the first polarization layer 302 and the liquid crystal layer L1, or between the liquid crystal layer L1 and the second polarization layer 305 (the latter is shown in FIG. 8A). Note that the user would view the output from the right side of FIG. 8A (as the light source would be on the left, see also FIG. 3). In a preferred embodiment the slot will be situated on the non-viewing side as this allows easy use of a touch screen in the client device 201.

In FIG. 8B, the construction of the liquid crystal display 701 is conventional, but a portion of the second polarization layer 305 has been omitted in the liquid crystal display 701. This portion is chosen to be large enough to accommodate superposition of the liquid crystal display 211 on the underlying liquid crystal layer L1.

In the construction of the liquid crystal display 211 a portion of one of the polarization layers has been omitted as well. Preferably this portion is of equal dimensions as the portion omitted in the liquid crystal display 701. This way, when superimposing the liquid crystal display 211 on the liquid crystal display 701, the liquid crystal layers L1 and L2 are directly put on top of each other, without intervening polarization layers.

In FIG. 8C the liquid crystal display 701 comprises a scattering mirror 802, rather than the first polarization filter 302. The second liquid crystal display 211 can now be inserted either between the first liquid crystal layer L1 and the polarization filter 305 or between the first liquid crystal layer L1 and the scattering mirror 802. In this embodiment no light source 301 is necessary, as incoming ambient light now serves as light source. This makes the display 701 in this embodiment a reflective liquid crystal display.

In this embodiment, the liquid crystal cells 303, 304 should rotate the incoming light at an angle half that of the transmissive case, as the light passes twice through the cells because of the mirror 802.

In FIG. 8D a transflective display 701 is used, comprising both the mirror 802 and the polarization filter 302. The mirror 802 is now realized as a mesh or grid, so that light coming from the backlight 301 (not shown) can pass through the mirror 802. Incoming ambient light can still be reflected by the mirror 802. This way, the user can activate the backlight if the incoming ambient light is insufficient to produce a clear image, or deactivate the backlight to save power. This is especially useful when the display 701 is comprised in a standalone device with a battery, like a mobile telephone.

It should be noted that the above-mentioned embodiments illustrate rather than limit the invention, and that those skilled in the art will be able to design many alternative embodiments without departing from the scope of the appended claims. For instance, the decryption device 210 can be incorporated in the lid of the client device 201, which makes properly positioning the display 211 over the display 701 trivial, as the relative positions are now fixed. Of course there should be no electronic connection between the lid and the client device 201, other than any mechanical connections necessary to open and/or close the lid.

In this construction two transmissing LCD displays are mounted on top of each other and the polarizers in between of the two liquid crystal cells are removed. Such a double display construction allows the handheld to be used in three modes of operation:
1) Normal mode: The display 701 functions like in the single-display case (and the second display is in transmissive mode). Possibly the display 211 can be used to compensate for color changes due to temperature variations. This is sometimes done in the automotive industry. The display 211 should then have a polarisation rotation in the opposite direction as the first. In this case the display 211 is not actively driven.
2) Security mode: The display 701 shows visually encrypted messages from a trusted party (e.g. the bank) to which the user is communicating over the network. The display 211 functions as a security display and shows the appropriate key pattern to visualize the plaintext to the user.
3) 3D mode: The two displays 701 and 211 are used to create a 3D viewing effect.

In security mode, the display 211 shows key patterns to visually decrypt information from the display 701.

One important note is that the key generating hardware should be physically separated from the device 201. However, in the above embodiment the device 210 is now integrated with device 201. Since we consider the device 201 as an untrusted device, its network connection and operating system should under no circumstances have access to the cryptographic key data that is displayed on the display 211. A secure way of fulfilling this requirement is by embedding an extra smart-card slot in the device 201. The user has to insert a special smart card to switch on the security mode of the device 201.

There are several implementation options:
The smart-card contains a list of keys that are directly used as key patterns for the display 211;
The smart-card contains the user's personal seed value (personal key) for a pseudo-random number generator (PRNG) which is used to generate the keys (or visual decryption key patterns). The PRNG is in the device 201 and only the seed and possibly a state-value are stored in the smart-card.
The smart-card contains both the personal seed value (personal key) and the PRNG. Key patterns provided by the smart-card are direct input for the display 211. This is the preferred embodiment since also the PRNG is now physically separated from the device 201.

The invention can be used in any kind of device in which a secure communication from a server to a client and/or vice versa is necessary. Client devices can be embodied as personal computers, laptops, mobile phones, palmtop computers, automated teller machines, public Internet access terminals, or in fact any client device that is not completely trusted by its user to not contain any malicious software or hardware.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of encoding a graphical message (220, 221) based on a key sequence as an encoded sequence of information units, comprising for each pixel of the graphical message (220, 221), said pixel having a normalized intensity I:
determining (511) a total rotation value a representing a rotation of a polarization of a cell in a liquid crystal display resulting in a pixel with substantially the intensity I,
choosing (512) an element α₂ from the key sequence, the element representing an arbitrary rotation of a polarization of a cell in a liquid crystal display,
computing (513) a first message value α₁ as a difference between the rotation value α and the element α₂, and
outputting (515) an element of the encoded sequence based on the first message value α₁.

2. The method of claim 1, further comprising computing an intermediate value x as x=arccos(|√(I)|) and determining the value a as either x or π−x.

3. The method of claim 1, in which the normalized intensity I corresponds to an intensity of a first color component of the pixel in question, and further comprising
repeating (521, 522, 523) the determining, choosing and computing steps' for a second rotation value corresponding to a normalized intensity of a second color component of said pixel to obtain a second message value,
repeating (531, 532, 533) the determining, choosing and computing steps for a third rotation value corresponding to a normalized intensity of a third color component of said pixel to obtain a third message value, and
outputting (515, 525, 535) the element of the encoded sequence further based on the second and third message values.

4. The method of claim 1, in which the intensity I is an element of a finite set with discrete values, the method further comprising choosing an offset Δ and adding (514) the offset Δ to at least one of: the first message value α₁ and the element α₂.

5. A computer program product arranged for causing a processor to execute the method of claim 1.

6. A device (201) for reconstructing a graphical message based on a key sequence, comprising
receiving means (702) for receiving an encoded sequence of information units,
a first liquid crystal display (701) arranged for displaying the sequence of information units by rotating the polarization of respective cells in a first liquid crystal layer (L1) by an amount indicated by respective elements in the encoded sequence,
a second liquid crystal display (211), different from the first liquid crystal display (701), arranged for rotating the polarization of respective cells in a second liquid crystal layer (L2) by an amount indicated by respective elements in the key sequence, in which the first (701) and second liquid crystal display (211) are arranged to be superimposed on each other.

7. The device (201) as claimed in claim 6, in which the first liquid crystal display comprises a reflective liquid crystal display.

8. The device (201) as claimed in claim 6, in which the second liquid crystal display is embodied in a unit (210) physically separable from the first liquid crystal display (701), and provided with a memory (212) for storing the key sequence.

9. The device (201) of claim 6, comprising means for receiving input representing a set of coordinates from a user, and means (702) for transmitting the received input to a server (200).

10. The device (201) of claim 9, in which the input is received as pressure on a particular spot of the first liquid crystal display (701), the set of coordinates corresponding to the particular spot.
